(19) United States
(12) Patent Application Publication
(10) Pub. No.: US 2018/0339265 A1
(43) Pub. Date: Nov. 29, 2018

(54) SYSTEM FOR TIME-SHIFTING POST-COMBUSTION CO2 CAPTURE

(71) Applicant: Bechtel Infrastructure and Power Corporation, Reston, VA (US)

(72) Inventors: William R. Elliott, Reston, VA (US); Seyfettin C. Gulen, Middletown, MD (US)

(21) Appl. No.: 15/605,221

(22) Filed: May 25, 2017

(51) Int. Cl. B01D 53/34; B01D 53/62; B01D 53/52; B01D 53/14; B01D 53/78; B01D 53/96

(52) U.S. Cl. CPC B01D 53/346; B01D 53/62; B01D 53/526; B01D 53/1475; B01D 53/78; B01D 53/96; B01D 2252/20431; B01D 2252/20405; B01D 2252/20426; B01D 2252/20489; B01D 2252/20421; B01D 2252/20484; B01D 2258/0283

(57) ABSTRACT

An undesirable constituent gas from the flue gas stream of a fossil fuel-fired power plant, especially carbon dioxide, CO₂, which is a potent greenhouse gas, is captured in a recirculating solvent-based absorption operation such as with an amine-based solvent. The solvent is exposed to flue gases for capture of the undesirable constituent, then heated to extract captured undesirable constituent for disposal, also regenerating the gas-rich solvent to gas-lean solvent for re-use. Absorption is continuous and uses the lean solvent at a rate proportional to the combustion rate. Solvent regeneration and its associated power loading are deferred and time-shifted to periods when the plant is operating below its peak power level. At high or peak power levels, rich solvent from absorption is accumulated in a storage vessel. At off-peak times, rich solvent accumulated in the storage vessel is regenerated together with rich solvent from concurrent absorption. Deferring regeneration to off peak (low price) times improves the peak (high price) output power level of which the plant is capable, and considerably increases revenue.

### FIELD OF THE INVENTION

This disclosure relates to apparatus and techniques for removal of an undesirable constituent gas, particularly carbon dioxide, a potent greenhouse gas, from stack (flue) gases, especially for a fossil fuel-fired electric power generation plant.

### BACKGROUND OF THE INVENTION

The invention facilitates efficient and cost-effective carbon dioxide removal by implementation of a removal technology that includes deferring the regeneration of used solvent (i.e., CO₂ rich solvent that has been exposed to flue gases) during times of peak demand for electricity. The stored solvent that would be regenerated concurrently with exposure to flue gases in a base loaded system is regenerated instead during off-peak demand periods. Among other results, the peak electric power output of the plant is increased and substantial cost savings are realized compared to base loaded carbon dioxide removal operations.

Carbon dioxide (CO₂) constitutes a large fraction of the greenhouse gases (GHG) that are widely believed to be a major contributor to climate change. As such, substantial research and development effort has been dedicated to reducing and/or eliminating emissions of CO₂ into the atmosphere. Combustion of fossil fuels in electricity generating power plants, especially coal, is a significant source of CO₂. To date, commercially available practical options for post-combustion CO₂ removal from stack gases have included deployment of aqueous amine-based absorber-stripper technology. This technology is applicable in general to removing CO₂ from flue gas streams, and can be incorporated into new power generation plants or retrofitted into existing plants.

In a fossil fuel-fired power plant with post-combustion capture, an absorber-stripper system operates concurrently with combustion. A flow of CO₂-lean solvent is exposed to the flue gas at a solvent flow rate that is sufficient in view of the flue gas flow rate to react with CO₂ from the flue gas stream and to capture the CO₂ in the solvent by chemical absorption. The now-CO₂-rich solvent is processed to extract and concentrate the CO₂ from the solvent for disposal, regenerating the solvent back to a CO₂-lean condition for reuse. The solvent flows in a recirculating flow path concurrently with combustion.

There are two main components of the CO₂ removal system, namely an absorber at which CO₂ is removed from the flue gas by exposure to the solvent, and a regenerator (stripper) at which CO₂ is extracted from the solvent and concentrated, and the solvent is thereby recovered. The CO₂ removal system of a fuel combustion power plant is powered by the plant, namely using some of the heat energy from combustion to heat the solvent in the stripper, and using some of the electric power from the plant's electric generators to power various pumps, compressors and controls. Therefore, although the plant produces electric power while releasing limited amounts of CO₂ into the atmosphere, the power generation capacity of the plant is also limited because some of the energy from the fuel has been devoted to removing and recovering CO₂ from the plant exhaust.

Prior to CO₂ removal, the flue gas (which gas is around 90° C. at the stack of an efficient gas turbine combined cycle or around 150° C. at the stack of an efficient coal-fired boiler power plant) is typically cooled to about 50° C. and then treated to reduce particulates that cause operational problems, and other impurities, some of which could lead to costly loss of the solvent (e.g., in a direct contact cooler or “quench tower”). The solvent absorbs the CO₂ (together with traces of NOx) by chemical reaction, to form a loosely bound compound. A booster fan (blower) is advantageous to overcome the pressure loss in the capture plant but is another significant (parasitic) power consumer to which part of the energy of the fuel is devoted.

A large power drain in the CO₂ capture system is due to the heat required to regenerate the solvent. The temperature level for regeneration is normally around 120° C. This heat is typically supplied by steam extracted from the steam cycle of the power plant and thus reduces the steam turbine power output and consequently reduces the net efficiency of the power plant.

As with other carbon capture technologies, electrical power also is consumed to compress captured CO₂ for transportation to a storage site, such as for injection of the heavier-than-air CO₂ into a storage cavern, oil field or other geological formations.

Various amine compositions are known for use as solvents treating gases for removal of CO₂, among other gases. The usual solvents comprise Diethanolamine (DEA), Monoethanolamine (MEA), Methyldiethanolamine (MDEA), Diisopropanolamine (DIPA), or Diglycolamine (DGA), etc. These are generally termed “amines.” For the present disclosure, MEA is a useful solvent and is an amine, but it should be appreciated that this disclosure applies to any solvent that is applied to remove CO₂ from power plant flue gases, and the spent or “rich” solvent is regenerated in a process for extracting the CO₂, and wherein the absorption and regeneration processes expend energy that the plant might otherwise use to produce electrical power.

Two taxing post-combustion CO₂ capture plant design challenges are to minimize regeneration exergy (or available work) needed, by selecting a solvent with a relatively low reaction energy, and to use the lowest possible energy steam extraction to provide the requisite energy. Minimizing regeneration energy is a worthwhile goal. (Using the steam source with the lowest possible exergy is a sine qua non design objective in any case.) Even at best, a substantial amount of fossil fuel-fired power plant energy will be invested to power CO₂ capture, solvent extraction and CO₂ compression operations in plants that employ CO₂ capture. It would be advantageous not only to seek to minimize regeneration energy but also to ameliorate other adverse impacts associated with CO₂ capture, which relate to power plant capacity and the financial gain that regeneration energy takes away from the power plant's bottom line. It is advantageous, and an object of the present invention, to tackle the problem with a system and method relying on such an alternative approach.

Accordingly, it is an object of the invention to extract an undesirable constituent, especially carbon dioxide, which is a potent GHG, from the stack or flue gas of a fossil fuel power plant by capturing the said gas in a recirculating solvent absorption operation such as with an amine solvent, but to time the regeneration of gas-rich solvent out of step with its production. More particularly, some or all of the regeneration of gas-rich solvent produced during peak power demand times is delayed. Regeneration of that gas-rich solvent is accomplished during off-peak power demand times, preferably together with regeneration of the gas-rich solvent that is being produced concurrently.

The removed constituent can be any flue gas fraction that is absorbed by the solvent upon exposure, and later is stripped from the solvent for re-use of the solvent, and for disposition of the stripped constituent. Advantageously, the constituent can be an undesirable constituent or set of constituents that are removed and disposed of to protect the atmosphere. Examples are greenhouse gases, especially CO₂. One or more constituents may be removed. The reasons for removal are not limited only to global warming concerns, for example in the case of removal of malodorous or corrosive flue gas components, especially H₂S.

The solvent is exposed to flue gases from combustion, for absorbing CO₂, resulting in gas-rich solvent from which captured CO₂ gas is extracted (i.e., “stripped”) for disposal by heating the gas-rich solvent. This regenerates the gas-rich solvent to gas-lean solvent for re-use in a recirculating manner. However, according to the invention, the absorption continuously uses lean solvent at a rate proportional to the combustion rate, but solvent regeneration (stripping) is deferred and time-shifted to periods when the plant is operating below its peak power level. This also shifts the drain on the power plant's heat and electrical energy output due to solvent regeneration away from peak power generation times to off-peak times.

Thus, at peak or high power levels above a predetermined threshold, rich solvent coming from flue gas absorption is accumulated in a storage vessel. At off-peak times, rich solvent that was accumulated in the storage vessel is regenerated together with rich solvent from concurrent absorption. Deferring regeneration (stripping) from peak to off-peak times improves the peak output power level of which the plant is capable, and considerably increases net income from power sales.

### BRIEF DESCRIPTION OF THE DRAWINGS

The drawings show certain exemplary embodiments for purposes of illustration. It should be understood, however, that the invention is not limited to the embodiments shown as examples and is capable of variation within the scope of the invention defined in the below claims. In the drawings,

FIG. 1 is a schematic illustration showing an exemplary configuration for carbon dioxide capture from flue gas, via aqueous amine-based absorption. The flue gas may be from any appropriate source that generates CO₂ that is advantageously removed rather than vented to the atmospheres, but is described with reference to the example of a power generation plant burning a fossil fuel.

FIG. 2 is a schematic illustration of operational elements and flows that according to the invention are varied over time, for operation of a CO₂ capture system substantially as exemplified by FIG. 1, advantageously resulting in improved efficiency, and limited costs, compared to steady state operation of a CO₂ capture system.

### DETAILED DESCRIPTION OF EXEMPLARY EMBODIMENTS

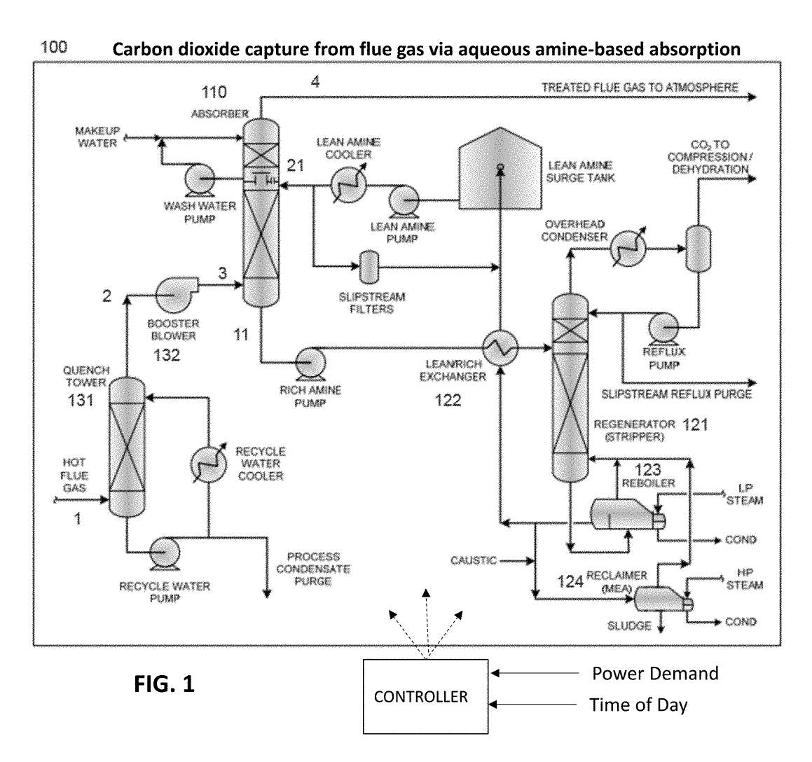

In FIG. 1, a solvent-based CO₂ capture system 100 to which the present invention is advantageously applied, has a generally conventional configuration but is operated according to the invention in a manner that alters operational parameters between peak and off-peak as well as transitional (e.g., startup) conditions.

A hot flue gas stream 1 from the stack of the power plant burning a fossil fuel (not specifically shown) goes first to a quench tower 131. Quench tower 131 includes a direct-contact heat exchanger utilizing water to cool the flue gas. The circulating water that contacts the flue gas stream 1 is cooled and filtered, which can constitute a means for removing particulates that may be present in the flue gas stream. After leaving the quench tower, a cooled flue gas stream 2 is passed into a booster fan (blower) 132 to maintain the required pressure in the inlet flue gas ducts.

On exiting the blower 132, the flue gas stream 3 enters an absorber 110, for example a vertical, packed column with a counter-flow arrangement. The flue gas stream 3 is contacted there with a solvent, typically an amine-based solvent. Carbon dioxide is absorbed from the flue gas stream into the lean solvent as it goes up the column. A treated flue gas stream 4 passes out through a wash section at the top section of the absorber. Preferably, less than 1 ppmv of entrained solvent is emitted to the atmosphere.

The lean solvent circulation rate is controlled, including by measuring the amount of CO₂ in the lean solvent feed stream 21 to the absorber. The control can be effected using a controller (not shown) coupled in a feedback control arrangement operable to control the pumps, valves, dampers and the like that affect the circulation rate.

The CO₂ solvent stream 11 leaves the absorber 110 and is sent for regeneration in the stripping system, where heat is provided to reversibly release the CO₂ from solution. In the example shown, this is accomplished at a kettle-type reboiler 123. Before entering the stripper 121, rich solvent is preheated by exchanging heat with the hot, lean solvent exiting the stripper in the heat exchanger 122.

A wash section at the top of the stripper ensures that a minimal amount of entrained and vaporized solvent leaves the column in the product CO₂ stream. To maintain an efficient operation and reduce solvent loss, a reclaimer 124 is operated in parallel to the reboiler 123 (e.g., as an intermittent batch process) to limit the build-up of heat-stable salts in the lean solvent.

Generally similar amine based CO₂ recovery processes typically take place with each of the sequentially operative elements in the gas and solvent flow paths functioning in a steady-state, continuous loop while the power plant in question is operating. The operational parameters are selected for appropriate levels at an operator-specified load level. The plant exhausts flue gas while generating and supplying electric power to the grid.

The net amount of electric power available to be supplied to the grid is diminished by the amount of “lost” steam turbine generator output that must be devoted to steam energy diverted to the stripper column reboiler. A considerable proportion of energy produced from fuel combustion is devoted to the CO₂ stripping operations. For example, in a pulverized coal-fired power plant (subcritical or supercritical) with a net rating of 550 MWe, regeneration steam-caused output loss may typically be 120 MWe.

In order to put this into terms of dollars and cents, one may consider the example of a time of peak demand for electrical energy. At peak demand, the price of electricity might be 120 $/MWh, for example. In that scenario, potential revenue of $14,400 is lost to the CO₂ stripping operation for each hour of peak-demand operation. If there are 1,000 hours of peak-demand operation in a typical year (8,760 hours), potential revenue loss is nearly $15 million annually.

In order to limit the total cost of CO₂ stripping operations in such a plant, and in view of the expected situation wherein demand for electricity varies over the course of a day or similar period into peak and off-peak periods, the current invention provides a modified system that is configured to time-shift part of the CO₂ stripping load into the off-peak periods. This is accomplished in part by using two solvent-storage tanks, one for the lean solvent and one for the rich solvent, arranged so that a substantial part of the stripper operational load is shifted to a time of off-peak demand. In this way, the $15 million annual revenue loss mentioned above is ameliorated by lower costs associated with stripper plant operations occurring at times of off-peak demand when electricity prices are significantly lower.

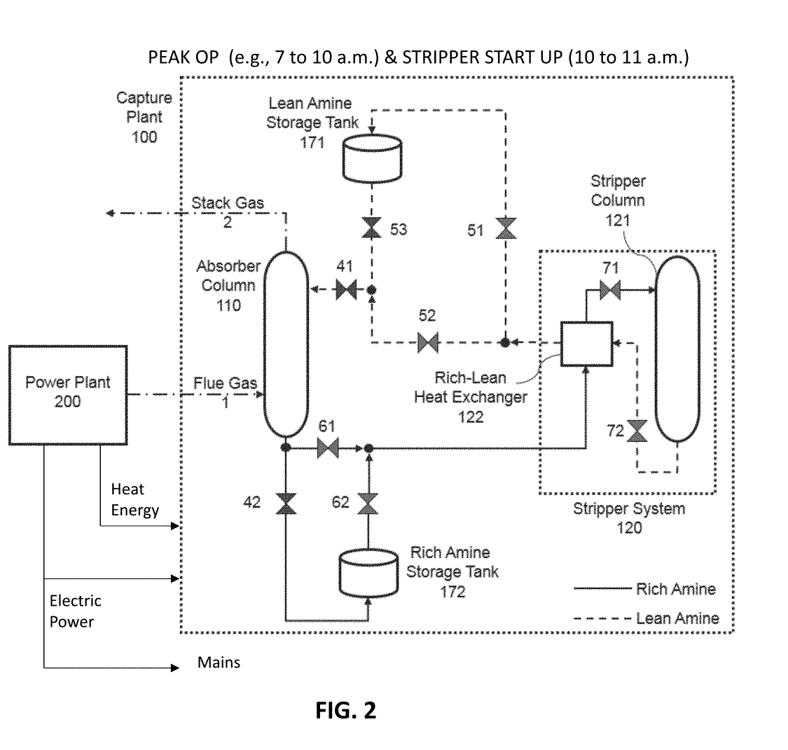

For a more detailed explanation and description of an operational example of the invention, an exemplary operational scenario is assumed with the following exemplary and non-limiting parameters (referring in particular to FIG. 2, which is a simplified version of the detailed system illustrated in FIG. 1 and described above). The flue gas is assumed to be the product of a generic fossil fuel-fired power plant 200, coupled to the amine-based post-combustion capture plant 100. Typically, there are 4 hours of peak operation in any 24-hour period, separated into two periods with maximum 3 hours in each period and minimum 7 hours in between. (These assumptions may vary in particular situations, seasons and the like.)

The stripper system 120 includes the rich-lean heat exchanger 122 (in order to store amine at ambient temperature) and all downstream CO₂ handling system.

Lean amine from the stripper column 121 advantageously is cooled before storage. This is best done by using the heat exchanger 122 against stripper feed. (Hot amine storage would need to be in pressurized vessels which could be prohibitively expensive for the expected volume. Degradation at temperature would also be an issue. Rich amine may need either some additional cooling or some dilution with lean amine to be stored safely in tanks substantially at atmospheric pressure.)

Rich amine can be stored directly from the absorber, as it is already cool.

Total volume of amine whether lean or rich stored in their respective tanks, 171 and 172, is assumed for purposes of discussion to remain constant (volume increase for CO₂ absorption will be ignored).

The absorber 110 requires 100 units/h of lean amine. Morning peak is 7 to 10 am and the evening peak is 5 to 6 pm. The stripper system 120 is assumed according to this example to be idle during peak operation. (Note that one hour advantageously is required to restart the stripper system.) Thus, the total daily operation time for stripper system is

24−4−2=18 hours.

In contrast, the CO₂ absorber is always in operation. The same quantity of CO₂ is in flue gas when power plant is operating in full power mode or steam extraction mode. Consequently, the absorber size is 100%. (Percentages herein refer to equivalent percentage for a system which would operate with all parts in operation 24 hours a day.)

The stripper system 120, including the rich-lean heat exchanger 122, is sized (100+X) %, where X is 33% because 24-hour worth of rich amine has to be processed in 18 hours when the power plant runs at 100% load throughout the entire period. This exploits the maximum possible operating and processing capacity of the power plant and the stripper system, respectively, in this operational scenario.

A sample chronology of one-day (24 hours) system operation is given below to demonstrate the operating philosophy of the invention. Note that this particular operating regime (i.e., 24 hours, non-stop, with 4 hours of 100% plant load and 20 hours of 25% plant load) is not intended to reflect a realistic dispatch scenario. It is presented merely to illustrate the operating philosophy in its entirety in a step-by-step manner with numerical values assigned to key operating parameters.

BEGIN (7 a.m.)
400 units of lean amine in the lean amine tank 171
0 units of rich amine in the rich amine tank 172

PEAK OPERATION (7 to 10 a.m.)
Power Plant 200 is ON in full power mode @ 100% Load
Absorber 110 is ON
Stripper system 120 is OFF
100 units/h lean amine from the lean amine tank 171 to the absorber 110 via valve 41 (open)
100 units/h rich amine from the absorber 110 to the rich amine tank 172 via valve 42 (open)

Tanks (10 a.m.)
100 units of lean amine in the lean amine tank 171
300 units of rich amine in the rich amine tank 172

STRIPPER START-UP (10 to 11 a.m.)
Power Plant 200 is ON @ 25% Load
Absorber 110 is ON
Stripper 121 STARTING UP
25 units/h of lean amine from the lean amine tank 171 to the absorber 110 via valve 41 (open)
25 units/h rich amine from the absorber 110 to the rich amine tank 172 via valve 42 (open)

Tanks (11 a.m.)
75 units of lean amine in the lean amine tank 171
325 units of rich amine in the rich amine tank 172

OFF-PEAK OPERATION (11 a.m. to 5 p.m.)
Power Plant 200 is ON @ 25% Load
Absorber 110 is ON
Stripper 121 is ON running at 50% load
25 units/h of rich amine from the absorber 110 to the stripper system 120
25 units/h of rich amine from the rich amine tank 172 to the stripper system 120
25 units/h of lean amine from the stripper system 120 to the absorber 110
25 units/h of lean amine from the stripper system 120 to the lean amine tank 172

Tanks (5 p.m.)
225 units of lean amine in the lean amine tank 171
175 units of rich amine in the rich amine tank 172

PEAK OPERATION (5 to 6 p.m.)
Same as before

Tanks (6 p.m.)
125 units of lean amine in the lean amine tank 171
275 units of rich amine in the rich amine tank 172

STRIPPER START-UP (6 to 7 p.m.)
Same as before

Tanks (7 p.m.)
100 units of lean amine in the lean amine tank 171
300 units of rich amine in the rich amine tank 172

OFF-PEAK OPERATION (7 p.m. to 7 a.m.)
Same as before

Tanks (7 a.m.)
400 units of lean amine in the lean amine tank 171
0 units rich amine in the rich amine tank 172

Although the invention is described using a generic amine as the solvent, which is the most common type of solvent used in capturing of carbon dioxide from a gas, the inventive system and method are applicable to any type of solvent wherein energy from the plant is devoted to the regeneration or recovery of the solvent.

The inventive system and method are independent of the type of major equipment used in the capture plant 100, i.e., absorber column 110, stripper column 121, rich-lean heat exchanger 122, etc. In other words, the columns can be randomly-packed or structured; the heat exchanger can be of shell-and-tube or printed-circuit type. Other similar variations are likewise possible and may be practical in particular circumstances.

The heart of the invention, as described in detail above, is the operating philosophy, i.e., the technique of “time-shifting” the regeneration process from a more expensive operational period, typically a period of peak electrical load, to a less expensive operational period, typically an off-peak load time period. This technique, in turn, is enabled by the disclosed plural solvent tank configuration (especially two tanks) that hold and transfer relatively richer and relatively leaner solvent during the different operational periods. Accordingly, the inventive system and the method described above are closely related.

The invention is advantageously implemented in a new-design CO₂ capture plant, based on an absorption-regeneration type of chemical solvent-based process. The invention also is advantageously applied to an existing capture plant by the addition of the two solvent storage tanks and associated balance of plant equipment (i.e., pipes, valves and pumps and controller that is either responsive to variations in loading or effects a daily or similar cycle over time). It is generally possible advantageously to retrofit most fossil fuel-fired power plants, provided that enough space is available and making the requisite software/hardware changes to the capture plant's distributed control system.

The apparatus and methods described provide an ability to dispatch the full generating capacity of the power plant at times of peak demand, when the highest wholesale price can be commanded, but to defer at least part of the energy devoted to solvent regeneration until off peak times at lower “lost” cost. The savings are substantial, which can be appreciated by sample calculations based on a hypothetical operating scenario. This is borne out in the following descriptive particulars that are generally closer to a realistic situation in an active fossil fuel-fired power plant than simple calculation above.

The plant used for discussion is assumed to be a supercritical, pulverized-coal power plant with 670 MWe net output. When the CO₂ capture plant of such a plant is in full operation, 120 MWe of steam turbine generator (STG) output is lost due to diversion of steam to the stripper regenerator. This brings down the amount of net power delivery to the grid to 550 MWe at 100% load.

Every day, the power plant is dispatched for 4 hours at 100% load at the time of peak demand when the wholesale electricity price is 12 cents per kilowatt-hour. The plant also runs at 50% load for 8 hours at the time of off-peak demand when the wholesale electricity price is 2 cents per kilowatt-hour. At other times, the power plant is off-line. The revenue picture for this modus operandi is given in the following TABLE 1.

When the invention is deployed to shift solvent regeneration load into off peak hours, the modus operandi is subjected to the following changes, which are reflected in the comparison TABLE 2 below, including the effects on revenue:
At times of peak load, the plant runs for 4 hours at 100% load and delivers 670 MWe to the grid (instead of 550 MWe). Those 4 hours are assumed to happen in two different times of day.
At times of off-peak load the plant runs for 8 hours as follows:
   For 2 hours at 50% load, 1 hour each for the start-up of the stripper, with 275 MWe delivered to the grid (same as in the base case)
   For 6 hours at 58% load, during which the stripper is run at 96% capacity (instead of 50%) to run down the inventory in the storage tanks; 275 MWe is delivered to the grid (same as in the base case)
In addition, the plant is run at 50% load for another 6 hours, when the wholesale electricity price is only 1.25 cents per kilowatt-hour, during which the stripper is run at 96% capacity to restore the storage tank levels to the beginning condition; 220 MWe is delivered to the grid.

Comparing Tables 1 and 2, the net benefit is $38K per day of operation (see TABLE 3). For an annual operating time of 4,500 hours in this rhythm, the accumulated net benefit is $9.5 million.

TABLE 3
Net revenue benefit of the invention

| | |
|---|---|
| Invention | $263,249 |
| Base | $225,257 |
| Net Benefit | $37,991 |

There are any number of specific scenarios possible, with different economic and/or dispatch combinations and considerations. In accordance with each unique combination, the net benefit of the invention might be lower or higher than the example. But it is indisputable that during each hour of operation at times of peak demand, by time shifting regeneration loading energy demands, the invention delivers 120 MWe extra peak load output to the grid. Consequently, the invention is guaranteed to make the proposition of a post-combustion capture plant much more feasible vis-à-vis the prior art without it.

With reference to FIG. 2, as a method for reducing emission of an undesirable gas constituent in flue gas 1 generated by an electric power plant that combusts fuel and has a cyclic variation in power demand level, the invention includes operating the power plant 200 by producing energy from combustion of the fuel. Relatively lean solvent that can absorb the undesirable constituent is exposed to flue gases 1 that result from the combustion, such that the lean solvent absorbs at least a portion of the undesirable constituent that is present. This can be accomplished in an absorber column 110, and produces rich solvent by absorption of the portion of the undesirable constituent, at a rate that is substantially proportional to the present rate of fuel combustion (which in turn is a function of the plant power output level and associated consumer demand for electricity). The solvent is chosen to be of a type wherein subsequent application of energy to the rich solvent causes the solvent to release the absorbed gas portion and to regenerate the solvent in lean condition. The solvent is regenerated, for example in a stripper column 121, where the absorbed fraction is released from the solvent and concentrated for disposal. The collected rich solvent is regenerated by applying to the rich solvent a portion of the energy that is produced by combustion of fuel in the power plant, which amounts to a drain on the power plant's ultimate capacity to generate electric power. In particular heat energy for operating the gas-fraction capture plant 100 is effectively diverted from the steam cycle of the power plant (not shown in FIG. 2), and operation of the various pumps and valves (shown only schematically in FIG. 2) likewise diverts electric power that would otherwise be applied to the electric mains.

Absorbing the undesirable constituent and collecting rich solvent is accomplished concurrently with the rate of fuel combustion. However, the method further comprises accumulating in storage at least part of the rich solvent produced during operation of the power plant at a relatively higher power demand level, and deferring regeneration of a stored part of the rich solvent to be regenerated during operation of the power plant at a relatively lower power demand level. In FIG. 2, for example, rich solvent is stored in a storage tank 172 for regeneration at off-peak times. During such off-peak times, the stripper 121 is operated to work on both the concurrently generated rich solvent from off-peak operations and the rich solvent that was previously stored in rich solvent storage tank 172. That is, lean solvent is regenerated at a rate greater than the lean solvent is being used by recirculation into the absorber column 110. Therefore, a lean storage tank 171 can be used to accumulate lean solvent that will later be needed to operate the absorber column to accommodate a combustion rate during peak times, which peak rate is greater than the rate at which solvent is then being regenerated by the stripper column 121, and optionally can be zero (i.e., no regeneration being done during peak power demand times).

The power plant advantageously operated by combustion of fossil fuel, especially coal. The absorbed undesirable constituent can be a greenhouse gas, especially carbon dioxide, CO₂. The solvent can comprise an amine solvent composition, for example containing one or more of diethanolamine, monoethanolamine, methyldiethanolamine, diisopropanolamine and aminoethoxyethanol (diglycolamine).

It is an aspect of the invention that there are cyclic or intermittent variations in the rate of generation of electric power, in the rate of application of the solvent to the flue gas in the absorber column, and in the regeneration of solvent by processing rich solvent in the stripper system for recirculation. In different specific applications, there may be different reasons for operating the power plant at different power generation rates, such as intermittent consumer demands for power. As a non-limiting example, the invention is described with reference to a typical cyclic variation in a daily cycle of power plant operational level due to daily variations in demand for power, which is predictable by factors that can be inputs to the plant controller that operates the plant including gas capture plant 100, such as the time of day (reduced consumer demand at night), the climate (higher demand for air conditioning on hot afternoons) and the like. The disclosed technique is applicable to such variations and can be controlled by such input factors. The technique is also applicable to irregular occurrences and accordingly the controller can also be arranged to respond to the present electric power demand level to alter the operation of the valves and pumps that circulate or store rich and lean solvent as described.

In any event, the rate of regeneration of rich solvent is reduced during the relatively higher power demand level periods, to a rate that is less than a rate at which the lean solvent is being applied during such periods to the flue gases that are produced by combustion in the power plant 200. The rate of regeneration of rich solvent optionally can be wholly discontinued during a power demand level above a predetermined threshold, while the absorber column continues to operate at a level proportional to the rate of combustion. Alternatively, the rate of regeneration can be relatively reduced at relatively higher combustion rates and increased at lower combustion rates in a continuously varying control scheme.

The elements of the apparatus for reducing emission of undesirable flue gas constituents (such as greenhouse gases) include the power plant 200 wherein combustion of fossil fuel produces energy converted to mechanical power and heat energy. The power plant can include at least one steam generator for producing steam and at least one electric generator for producing electric power. The power plant is subject to variation in demand for electric power and operates at times up to and at other times below a peak demand level of which the power plant is capable when operating at full capacity.

A gas capture unit 100 is operated using one or both of heat energy and electrical energy that is produced by the power plant 200 and constitutes a drain on the level of power output to the mains, at which the power plant otherwise would be capable of operating, namely without using heat and electrical energy to remove, concentrate and dispose of the undesirable constituent so as to prevent release in the stack gas 2 of a least some of the undesirable constituent present in the flue gas 1.

The gas capture unit 100 includes a flue gas treatment element such as absorber column 110, at which combustion exhaust gas is exposed to a solvent that absorbs at least one undesirable constituent (such as CO₂, which is a potent GHG). The gas capture unit 100 includes a solvent regeneration element 121 at which solvent made rich with the undesirable constituent by exposure is heated to release absorbed undesirable constituent, thus making the solvent lean and ready for re-use. The gas capture unit further comprises associated vessels 171, 172, pumps and valves (41 through 72) for supporting and guiding flow of the lean solvent to accomplish flue gas exposure for entraining absorbed gas and lean solvent regeneration by application of heat, all powered substantially from the energy produced by the power plant from the fossil fuel.

The controls coupled to the gas capture unit operate to vary the time and/or rate of operation of the associated vessels (filling and emptying), pumps and valves, at least generally according to the demand for electric power. This can be accomplished, for example by feedback control loops responsive the power output level, or by threshold detection to alter operations above and below a predetermined given power level, or by predictions based on other input factors such as the time of day, etc.

The exposure of lean solvent to the combustion exhaust gas is supported by a solvent flow rate at the flue gas treatment element (absorber column 110) that is related to (e.g., substantially proportional to) the rate of fuel combustion by the power plant 200. The power requirements of the solvent regeneration element (stripper column 121) are related (e.g., substantially proportional) to a solvent flow rate through the solvent regeneration element 121.

The apparatus further comprises a storage vessel for rich solvent, coupled between the flue gas treatment element and the solvent regeneration element, used for accumulating rich solvent during periods when rate of generation of rich solvent exceeds the rate at which rich solvent is regenerated into lean solvent and re-used in a circulating configuration. Advantageously and as shown in the exemplary embodiment in FIG. 2, the apparatus can also comprise a storage vessel for lean solvent for accumulating lean solvent during periods when the rate of generation of lean solvent exceeds the rate at which lean solvent is being applied to flue gas in the absorber column.

These elements are arranged cyclically to accumulate rich solvent in the storage vessel by maintaining a faster solvent flow rate through the flue gas treatment element than through the solvent regeneration element during periods of relatively higher demand for electric power, thereby deferring at least part of the energy needed to regenerate solvent made rich during the periods of relatively higher demand, into periods of relatively lower demand. For this purpose, controls are provided for altering the flow directions and rates of flow of rich and lean solvent. The controls can be integrated into a comprehensive plant control system or separate and can be automatic controls or manual controls that are adjusted by the plant operators as needed.

In one example, the controls are at least partly responsive to the time of day to correspond to a predicted peak demand time. In another example, the controls are proportional and based at least partly on the instantaneous level of demand for electric power. In still another example, the controls can be configured to reduce a processing rate of regeneration from the storage vessel when demand for power exceeds a predetermined threshold, and to increase a processing rate of regeneration from the storage vessel, when demand for power falls below a predetermined threshold. In one embodiment regeneration from the storage vessel is wholly discontinued when demand for power exceeds a predetermined threshold.

The stripper system 120 operates at least partly using heat energy from the plant 120, diverted from the plant's steam cycle. The various pumps and valves divert electric power generated by the power plant that would otherwise go to the power mains. Deferring or time shifting the regeneration of some of the rich amine from peak to off-peak power demand times enables more energy to be provided to the electric power mains during peak times when energy is likely to be more highly priced, and also increases the maximum electric power output capacity of the plant (i.e., at peak demand times) to a higher level than would otherwise be possible using a baseline solvent regeneration scheme wherein solvent regeneration always is carried out at the same rate that rich solvent is produced, namely at the same rate that regenerated lean solvent is applied to the flue gases.

The invention has been described with respect to certain examples of equipment and operational scenarios that illustrate the structures, method steps and advantages of the invention. It will be appreciated that the invention is not limited to the specific examples discussed. Reference should be made to the appended claims rather than the foregoing examples in order to assess the scope of exclusive rights claimed

1. A method for reducing emission of a constituent in flue gases generated by an electric power plant that combusts fuel and has a cyclic variation in power demand level, comprising:
operating the power plant by producing energy from combustion of the fuel;
exposing lean solvent to flue gases that result from the combustion, the lean solvent absorbing from the flue gases a portion of the constituent, thereby producing rich solvent by absorption of the portion of the constituent, and wherein the rich solvent is effective upon application of energy to the rich solvent to release the gas portion and to regenerate the solvent in lean condition;
collecting the rich solvent and applying to the rich solvent a portion of the energy that is produced by said combustion in the power plant, thereby releasing the gas portion and regenerating lean solvent for re-use;
collecting and disposing of the gas portion released by the rich solvent;
said method further comprising accumulating in storage at least part of the rich solvent produced during operation of the power plant at a relatively higher power demand level, and deferring regeneration of a stored part of the rich solvent that is regenerated during operation of the power plant at a relatively lower power demand level.

2. The method of claim 1, wherein the power plant includes combustion of fossil fuel and the constituent can be a greenhouse gas such as CO₂.

3. The method of claim 2, wherein the power plant includes combustion of coal and the constituent comprises carbon dioxide.

4. The method of claim 1, wherein the cyclic variation corresponds to a daily cycle of power plant operational level.

5. The method of claim 1, wherein the cyclic variation corresponds to a daily cycle of consumer demand for electric power.

6. The method of claim 1, wherein a rate of regeneration of the rich solvent is reduced during the relatively higher power demand level to a rate that is less than a rate at which the lean solvent is applied to the flue gases.

7. The method of claim 1, wherein regeneration of the rich solvent is discontinued during a power demand level above a predetermined threshold.

8. The method of claim 1, wherein the solvent comprises an amine composition.

9. The method of claim 8, wherein the solvent is selected from the group consisting of diethanolamine, monoethanolamine, methyldiethanolamine, diisopropanolamine and aminoethoxyethanol (diglycolamine).

10. An apparatus for reducing emission of flue gas constituents, comprising:
a power plant wherein combustion of fossil fuel produces energy converted to mechanical power and heat energy, the power plant including at least one steam generator and at least one electric generator, wherein the power plant is subject to variation in demand for electric power below a peak demand level of which the power plant is capable;
a gas capture unit powered by the power plant, whereby a portion of the energy produced by the power plant is devoted to operating the gas capture unit;
wherein the gas capture unit comprises a flue gas treatment element at which combustion exhaust gas is exposed to a solvent that absorbs at least one constituent, and a solvent regeneration element at which solvent made rich with the constituent by exposure is heated to release absorbed constituent and made lean, the gas absorption unit further comprising associated vessels, pumps and valves for supporting flow of the lean solvent for exposure and the lean solvent for regeneration, all powered substantially from the energy produced by the power plant from the fossil fuel;
controls coupled to the gas capture unit operable to vary operation of the associated vessels, pumps and valves as a function of the demand for electric power;
wherein exposure of the lean solvent to the combustion exhaust gas is supported by a solvent flow rate at the flue gas treatment element that is substantially proportional to a rate of combustion;
wherein power requirements of the solvent regeneration element are substantially proportional to a solvent flow rate through the solvent regeneration element;
said apparatus further comprising a storage vessel for rich solvent, coupled between the flue gas treatment element and the solvent regeneration element;
wherein the controls are arranged cyclically to accumulate rich solvent in the storage vessel by maintaining a faster solvent flow rate through the flue gas treatment element than through the solvent regeneration element during periods of relatively higher demand for electric power, thereby deferring at least part of the energy needed to regenerate solvent made rich during the periods of relatively higher demand, into periods of relatively lower demand.

11. The apparatus of claim 10, wherein the controls are based on time of day to correspond to a predicted peak demand time.

12. The apparatus of claim 10, wherein the controls are proportional based on instantaneous level of demand for electric power.

13. The apparatus of claim 10, wherein the controls are configured to reduce a processing rate of regeneration from the storage vessel, when demand for power exceeds a predetermined threshold.

14. The apparatus of claim 10, wherein the controls are configured to increase a processing rate of regeneration from the storage vessel, when demand for power falls below a predetermined threshold.

15. The apparatus of claim 10, wherein the controls are configured to discontinue regeneration from the storage vessel, when demand for power exceeds a predetermined threshold.

16. The apparatus of claim 10, wherein the pumps and compressors are driven using electric power generated by the power plant.

17. The apparatus of claim 10, wherein the regeneration uses combustion heat energy from the plant, diverted from the steam cycle.
